(19) United States
(12) Patent Application Publication
(10) Pub. No.: US 2003/0226706 A1
(43) Pub. Date: Dec. 11, 2003

(54) Anti-theft device for motor vehicles

(76) Inventors: Roy J. Dixon, Royal Palm Beach, FL (US); Revell Dixon, Royal Palm Beach, FL (US)

Correspondence Address: MCHALE & SLAVIN, P.A., 2855 PGA BLVD, PALM BEACH GARDENS, FL, 33410, US

(21) Appl. No.: 10/165,539

(22) Filed: Jun. 8, 2002

(51) Int. Cl. B60R 25/00

(52) U.S. Cl. 180/287

(57) ABSTRACT

A motor vehicle anti-theft apparatus is operable to erect a locked physical barrier to prohibit access to the the foot pedal assembly. The device includes a pair of vertically mounted guides which are mounted on either side of the foot pedal assembly between the pedals and the operator. A rod is rotatably mounted horizontally between the left and right channels proximate to the upper ends of the channels, and a shutter assembly is fixedly attached to the rod and is slidably disposed in the vertically mounted guides. The shutter assembly includes a plurality of elongated rectangular panels having an articulated linkage to one another wherein rotation of the rod causes the shutter assembly to be successively wrapped around the rod. The shutter assembly can be moved between an extended and retracted position wherein the retracted position permits access to the foot pedal assembly and the extended position provides a physical barrier to the foot pedal assembly. The device includes a means for locking said shutter assembly in said extended position. The device can include a drive means coupled to the vehicle electrical system which is operable to move the shutter assembly between the extended and retracted positions. The locking means can be operable by a mechanical linkage in electrical communication with the vehicle electrical system to allow the locking means to be released.

### FIELD OF THE INVENTION

This invention relates generally to the field of anti-theft devices for automobiles, and more particularly to an anti-theft device which provides a locked physical barrier to prohibit access to the foot pedal assembly of an automobile.

### BACKGROUND OF THE INVENTION

There are numerous systems in the prior art designed to prevent the theft of a motor vehicle. Such devices include alarm systems, preventative mechanical features, after-market locks, etc. Many automobile owners will, for example, choose to supplement standard door locks with an electronic alarm. When triggered, these alarms may emit loud sounds and trigger flashing lights; some alarms may even disable a vehicle fuel pump or starter motor. Unfortunately, these devices may be a nuisance if triggered accidently, may be disabled by experienced thieves, and will not operate if the battery is dead.

From a practical standpoint, the physical immobilization of a vehicle by visible means is a very effective theft deterrent. Also, having a highly visible, seemingly impenetrable theft prevention device on the vehicle provides an element of psychological deterrence.

One example of this type of device are those which secure vehicles by encumbering the vehicle steering wheel. These devices telescopically engage a vehicle steering wheel make the steering wheel difficult to use by striking internal portions of the vehicle as attempts to turn the wheel are made. Unfortunately, these devices may often be defeated by strategically cutting away portions of the steering wheel and simply removing the lock.

Other locking devices use cooperating plates and bars to secure the pedals of a vehicle. U.S. Pat. No. 4,076,095, for example, discloses a pedal locking device that includes a pair of parallel bars which simultaneously sandwich the support stems of an automobile clutch and brake pedal. Integrated spacers keep the bars and the engaged pedals from being depressed while the device is locked in place. Although this type of lock may make driving difficult and could deter inexperienced thieves, the '095 device may be defeated by a determined individual having tools to cut the parallel bars, thereby rendering the device easy to remove. U.S. Pat. No. 5,094,092 also discloses a pedal locking device that uses bars and spacer legs to prevent motion of engaged pedals. As with other devices of this sort, the '092 device is vulnerable to physical attack and may be defeated simply by cutting through exposed portions and removing the device.

Other locking devices resemble specialized clamps and engage a chosen pedal to make the pedal difficult to move. U.S. Pat. Nos. 6,298,696, 3,613,410, 4,493,198 and 5,359,868 each disclose an example of this type of device. U.S. Pat. No. 6,085,559 similarly discloses lockbox which fits over the accelerator pedal. While these devices may encumber a selected pedal, this type of device does not effectively deter theft in all cases. For example, vehicles having a locked brake pedal may still be driven through use of the accompanying emergency brake. Additionally, vehicles having just an accelerator pedal blocked may be placed in a neutral gear and pushed to a remote location where the lock may be attacked until destroyed. A major disadvantage of all such devices is that they require full physical removal in order to operate the motor vehicle.

U.S. Pat. No. 4,632,209 discloses an anti-theft locking device for blocking the use of automobile foot pedals. A first rigid plate, hingedly attached to the floor of the vehicle, is moved from a stored position adjacent and parallel to the floor to a blocking position perpendicular to the floor. A second rigid plate, hingedly attached to the first rigid plate perpendicular to the floor, is then moved from a stored position adjacent and parallel to the first plate to a position adjacent the console where the second plate is secured in place with a padlock. Although the device does provide a physical barrier to access of any or all pedals, the device can easily be defeated by simply cutting off the padlock.

Theft prevention devices can generally be categorized as “active” or “passive.” Passive devices are in automatic, continuous operation and need not be engaged by the driver upon exiting the vehicle. The prior art devices described above, which serve to physically immobilize the vehicle, are all active devices in that they must be deployed by the driver if they are to be effective. Obviously, passive devices are much more effective in this respect since it will often happen that there will be circumstances in which the driver will neglect to engage the active device. Thus, what is needed in the art to provide optimal theft protection is a physical barrier device which can be passively engaged.

### SUMMARY OF THE INVENTION

It is an objective of the invention to provide an improved motor vehicle theft prevention device which provides a locked physical barrier to prohibit access to the vehicle pedal assembly.

It is another objective to provide a locked physical barrier to the vehicle pedal assembly which can be quickly and easily engaged and disengaged.

It is still another objective to provide a locked physical barrier to the vehicle pedal assembly which can be passively engaged.

It is a further objective of the invention to provide a locked physical barrier to the vehicle pedal assembly having a drive mans which is coupled to the vehicle electrical system.

It is yet a further objective of the invention to provide a locked physical barrier to the vehicle pedal assembly which can either be factory-installed or retro-fit into an existing vehicle.

In accordance with the above objectives, an anti-theft apparatus operable to erect a locked physical barrier to prohibit access to the the foot pedal assembly of a motor vehicle is provided. The device includes a pair of vertically mounted guides in the form of U-shaped left and right channels which are mounted on either side and forward from the foot pedal assembly. The guides extend at from at least the lower surface of the vehicle dashboard to the vehicle floor. A rod is rotatably mounted horizontally between the left and right channels proximate to the upper ends of the channels. A shutter assembly is fixedly attached to the rod and is slidably disposed in the left and right channels. The shutter assembly includes a plurality of elongated rectangular panels having an articulated linkage to one another wherein rotation of said the rod causes the shutter assembly to be successively wrapped around the rod. The shutter assembly can be moved between an extended and retracted position wherein the retracted position permits access to the foot pedal assembly and the extended position provides a physical barrier to the foot pedal assembly. The device includes a means for locking said shutter assembly in said extended position. The locking means can include a locking member which secures the shutter assembly to at least one of the left and right channels. The locking member can be mechanically linked to a manually actuatable locking device, such as a key-operable tumbler lock.

The device can include a drive means coupled to the vehicle electrical system which is operable to move the shutter assembly between the extended and retracted positions. The locking member can be operable by a mechanical linkage in electrical communication with the vehicle electrical system to allow the locking member to be released. The drive means can be a bi-directional electric motor in operative communication with said rod.

To move the shutter assembly between the extended and retracted positions, an actuating means electrically coupled to said drive means and said locking member. The actuating means can comprise an engine starting key with a readable memory means which has a unique identifying code stored therein, a key receiving socket including a means for reading the identifying code, a means for comparing the identifying code with a previously stored code for verification, and a means for verifying the identifying code. The actuating means is operable to unlock the locking member and move the shutter assembly to the retracted position when the identifying code is verified, and moves the shutter assembly to said the extended position and locks the locking member when the key is removed from the key receiving socket.

The device can include a sensing means operable to detect intervening objects proximate to said shutter assembly in an open position in order to prevent the shutter assembly from lowering to the closed position if there intervening objects are detected. The sensing means can be an optical sensor.

In another embodiment of the invention, the drive means can comprise a hydraulic pump motor fluidly connected to a pair of left and right hydraulic piston rod assemblies mounted on either side and forward from the foot pedal assembly. The hydraulic piston rod assemblies respectively include left and right vertically displaceable piston rods which are fixedly attached to a portion of said shutter assembly to allow the shutter assembly to be extended and retracted by vertical displacement of the piston rods.

### BRIEF DESCRIPTION OF THE FIGURES

FIG. 1 illustrates a preferred embodiment of the invention according to a preferred embodiment installed in a motor vehicle;

FIG. 2 is a cross-sectional view taken along the line 2-2 of the embodiment shown in FIG. 1;

FIG. 3 is a cross-sectional view taken along the line 3-3 of the embodiment shown in FIG. 1;

FIG. 4 illustrates an alternative embodiment in which the device of the invention is operatively coupled to the vehicle electrical system;

FIG. 5 illustrates the operative steps of the actuating means of the invention; and

FIG. 6 illustrates another alternative embodiment of the invention utilizing a hydraulic pump motor.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention. The scope of the invention is defined by the claims appended hereto.

FIG. 1 illustrates the device 10 installed in a motor vehicle. In FIG. 1, the device 10 is illustrated in an engaged mode in which the motor vehicle is effectively immobilized.

The device 10 of the invention can be factory-installed into new vehicles, or alternatively, it can be retro-fitted into existing vehicles. The device 10 includes a rollable shutter assembly 14 which, in the closed, extended position, prohibits access to the vehicle pedal assembly 9.

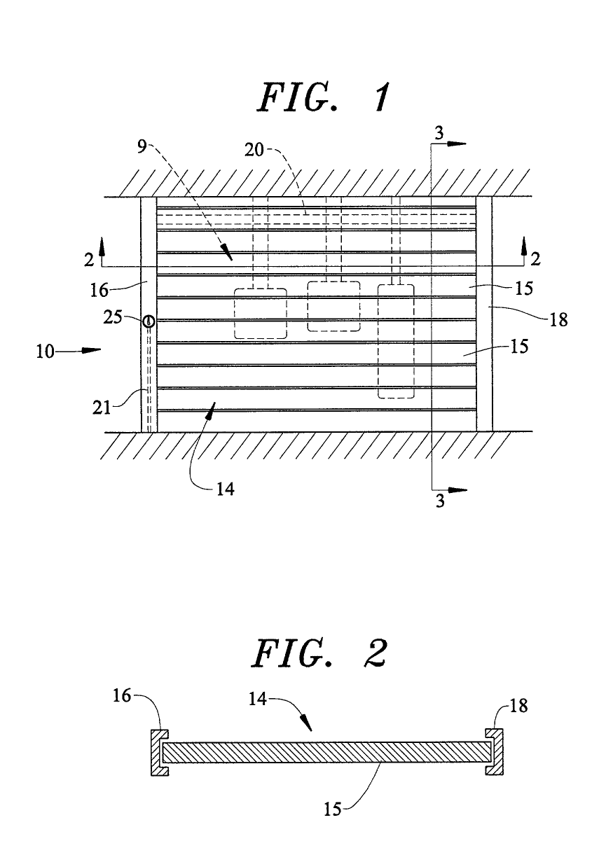

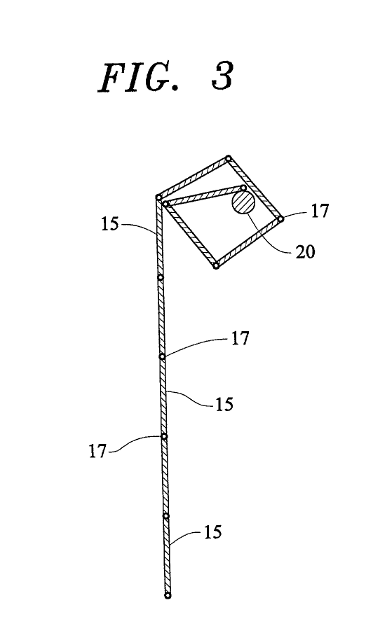

The components of the device I/O are preferably constructed from a high-strength, inflexible material, such as steel, to thwart tampering. The device I/O includes a pair of vertically oriented guides which are mounted on either side and forward from the pedal assembly 9. In the preferred embodiment, the guides are formed as left and right channels 16 and 18 having a U-shaped cross-sectional configuration, as is shown in FIG. 2. The upper ends of the left and right channels 16, 18 extend from at least the lower surface of the vehicle dashboard 8 to the floor 7 of the vehicle. The shutter assembly 14 is slidably disposed in the left and right channels 16, 18. A rod 20 is rotatably mounted proximate to the upper end of the left and right channels 16, 18. As seen in the FIG. 3, the upper edge of the shutter assembly is attached to the rod 20. The shutter assembly 14 is preferably constructed from a plurality of elongated rectangular panels 15 which having articulated linkages 17 to one another allowing the shutter assembly 14 to be successively wrapped around the rod. The shutter assembly 14 can thus be moved between extended and retracted positions by alternately urging the shutter assembly 14 upward so that it wraps around the rod 20, or by pulling the shutter assembly 14 downward. In a manual mode of operation, the shutter assembly 14 is constructed so that frictional engagement maintains the shutter assembly 14 in the retracted position.

A locking means is provided to maintain the shutter assembly 14 in the extended position. For manual operation, the invention contemplates any number of locking arrangements. To effectively lock the device 10, the shutter assembly 14 is secured to at least one of the left and right channels 16, 18. The shutter assembly 14 can include a locking member, such as a locking pin 21, which is housed in the left channel 18 and is seated in an aperture which is located in a lower portion of the shutter assembly 14 in the locked position. A manually actuatable locking mechanism operatively engaged with the locking pin 21, such as the key-operated tumbler lock 25, can be used to selectively lock and unlock the locking pin 21. A locking mechanism can also be used to lock the rotatable rod in position to prevent opening of the shutter assembly 14.

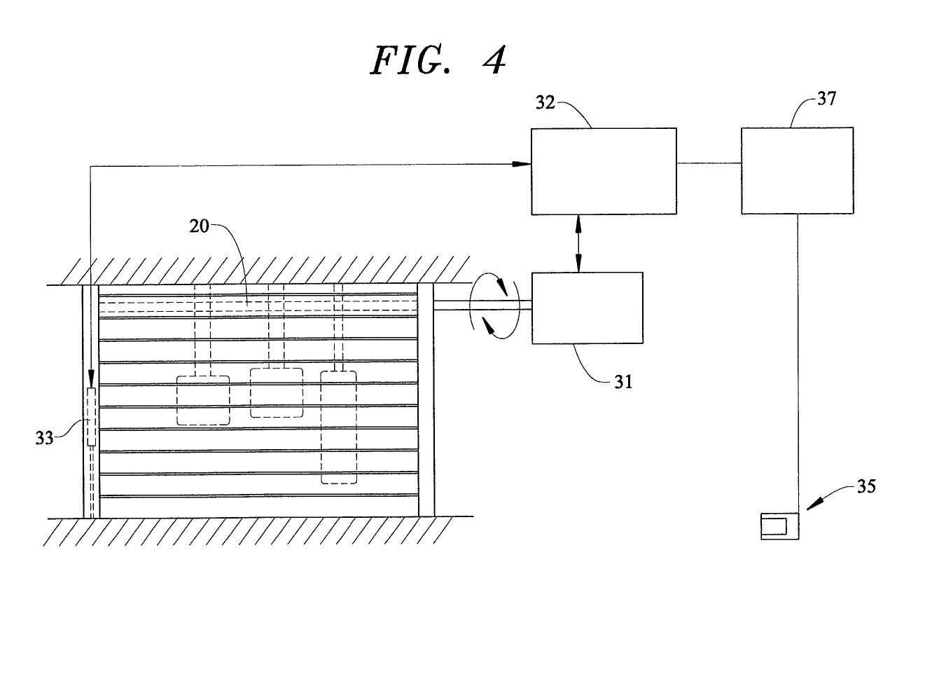

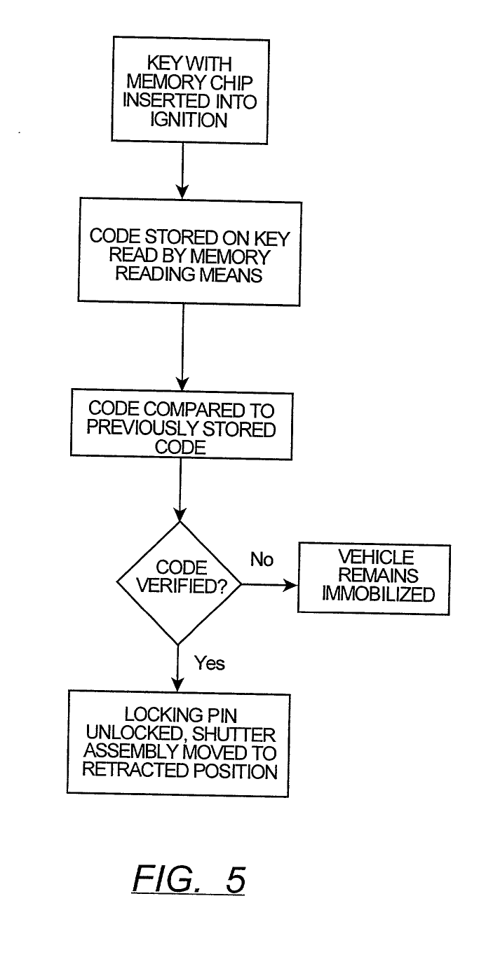

To allow “passive” engagement of the theft-prevention device of the invention, the device 10 can be coupled to the vehicle electrical system 32, as shown in FIG. 4. In this embodiment, the rotatable rod 20 is coupled to a drive means, such as bidirectional motor 31, which can be powered by the vehicle battery. A locking means, such as locking pin 33, is operated by a mechanical linkage in electrical communication with the vehicle electrical system. The process of extending and locking he shutter assembly 14 can thus be electronically controlled.

An actuating means 37 is used to operate the device 10. In the preferred embodiment, the actuating means is implemented using an ignition key having a readable memory means stored thereon, a system well-known in the art. A unique identifying code is stored in the memory chip incorporated into the key. The key receiving socket in the vehicle has a means for reading, identifying, and verifying the code. As shown in FIG. 5, when the key is inserted into the ignition, the code is read, and then compared with a previously stored code for verification. If the code is verified, the locking pin is unlocked, and the bi-directional electric motor rotated the rod until the shutter assembly is moved to a retracted position. The vehicle can then be operated by the driver. When the key is removed from the ignition, the rod is rotated until the shutter assembly is in an extended, closed position, and the locking pin is engaged to lock the shutter assembly in place.

In an electronic mode of operation, the device 10 includes a sensing means 35 to detect if there are any intervening objects between the shutter assembly and the floor of the vehicle, such as the feet of the driver. If an intervening object is detected, the lowering of the shutter assembly 14 is halted until the intervening object is removed. The sensing means 35 can be an optical sensor, such as a laser or infrared device.

In an electronic mode of operation, the actuating means can be implemented in any number of ways in addition to that described above. For example the vehicle can include an additional key receiving socket independent of the ignition key socket. The device 10 can also be operated by entering a predetermined code into keypad, thus allowing the operator to change the access code as might be necessary.

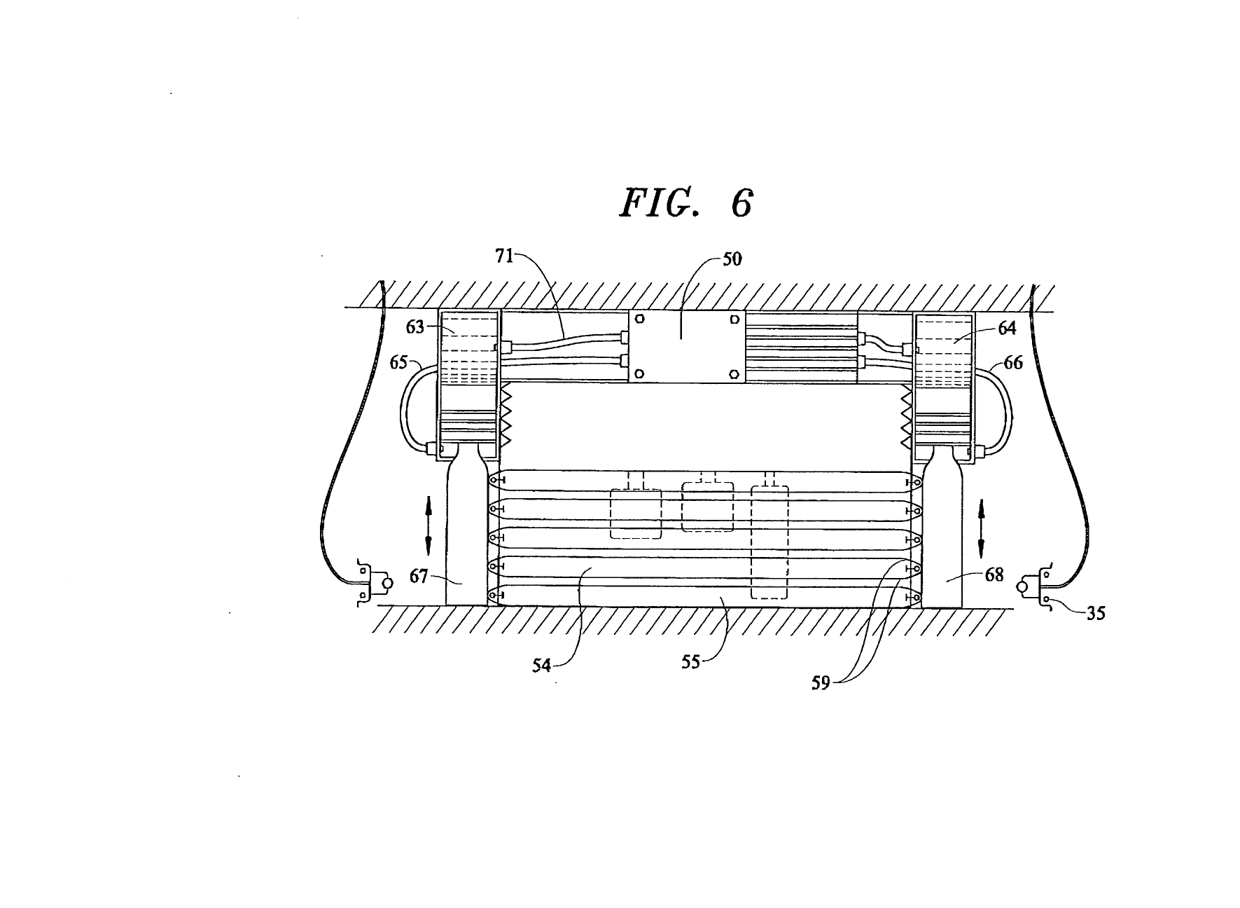

In another embodiment of the invention shown in FIG. 6, the drive means can be the hydraulic pump 50. The shutter assembly 54 is slidably disposed in left and right U-shaped channels 56 and 58. The shutter assembly 54 is constructed from a plurality of elongate panels 55. As shown in FIG. 6, the shutter assembly 54 includes articulated linkages 59 between panels 55 which allows zig-zag folding of the adjacent panels with respect to one another. The hydraulic pump motor 50 is fluidly connected via hydraulic compression line valves 71, 72 to a pair of left and right hydraulic piston rod assemblies 61,62 which are mounted on either side and forward from the foot pedal assembly 9. The piston rod assemblies 61,62 include cylinder chambers 63,64, hydraulic lift line valves 65,66 and piston rods 67, 68. The piston rods 67, 68 are fixedly attached to the lower portion of shutter assembly 54. The piston rods 67, 68 are vertically displaceable by operation of the hydraulic pump motor 50. Vertical displacement of the piston rods 67,68 moves the shutter assembly 54 between extended and retracted positions. The hydraulic pump motor 50 can be coupled to an electronic actuating means and a sensing means in the manner discussed above. The force exerted by the hydraulic piston rod assemblies 61,62 prevents lifting of the shutter assembly 54 and effectively locks it in place.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

I claim:

1. An anti-theft apparatus operable to erect a physical barrier to prohibit access to the the foot pedal assembly of a motor vehicle, comprising:
guide adapted to be mounted in a motor vehicle between the operator and the foot pedal assembly;
a shutter assembly between each panel having a plurality of elongated panels and an articulated linkage, said linkage including a rotatable rod wherein rotation of said rod causes said shutter assembly to be successively wrapped around said rod, said guide movably engaging the end of said plurality of elongated panels;
said shutter assembly movable between extended and retracted positions, wherein said retracted position permits access to the foot pedal assembly and the extended position provides a physical barrier to said foot pedal assembly.

2. The anti-theft apparatus of claim 1 comprising a locking means wherein said means for locking said shutter assembly in said extended position comprises at least one selectively retractable locking member which secures said shutter assembly to at least one of said left and right channels.

3. The anti-theft apparatus of claim 2, wherein said at least one selectively retractable locking member is mechanically linked to a manually actuatable locking device.

4. The anti-theft apparatus of claim 2, wherein said at least one selectively retractable locking member is mechanically linked to a manually actuatable locking device.

5. The anti-theft apparatus of claim 4, wherein said manually actuatable locking device comprises a key-openable tumbler lock.

6. An anti-theft apparatus operable to erect a physical barrier to prohibit access to the the foot pedal assembly of a motor vehicle having an electrical system, comprising:
a guide adapted to be mounted on either side of the foot pedal assembly, said guide comprising left and right channels having a U-shaped cross section, said left and right channels having an upper end extending above the foot pedal assembly and a lower end fixedly attached to the vehicle floor;
a rod rotatably mounted horizontally between said left and right channels proximate to the upper ends of said channels;
a shutter assembly movably attached to said rod, said shutter assembly comprising a plurality of elongated rectangular panels having an articulated linkage to one another wherein rotation of said rod causes said shutter assembly to be successively wrapped around said rod; the ends of said plurality of panels slidably disposed in said left and right channels and movable between extended and retracted positions, wherein said retracted position permits access to the foot pedal assembly and the extended position provides a physical barrier to said foot pedal assembly, and
a drive means for moving said shutter assembly between said extended and retracted positions, wherein said drive means is coupled to the vehicle electrical system and said rod.

7. The anti-theft apparatus of claim 6 comprising a locking member for locking said shutter assembly in said extended position, said locking member being operable by a mechanical linkage in electrical communication with the vehicle electrical system, wherein said locking member can be released to allow said shutter assembly to be moved to said retracted position.

8. The anti-theft apparatus of claim 6, wherein said drive means is a bi-directional electric motor.

9. The anti-theft apparatus of claim 7, further including an actuating means electrically coupled to said drive means and said locking member.

10. The anti-theft apparatus of claim 8, wherein said actuating means comprises:
an engine starting key having readable memory means having a unique identifying code stored therein;
key receiving socket mounted in the vehicle, said key receiving means having a means for reading said identifying code;
means for comparing said identifying code with previously stored code for verification; and
means for verifying said identifying code.

11. The anti-theft apparatus of claim 7, wherein said actuating means moves said shutter assembly to said extended position and locks said locking member when said key is removed from said key receiving socket.

12. The anti-theft apparatus of claim 6, further comprising a sensing means, wherein said sensing means is operable to detect intervening objects proximate to said shutter assembly in an open position, wherein detection of intervening objects will prevent said shutter assembly from lowering to said closed position.

13. The anti-theft apparatus of claim 12, wherein said sensing means is an optical sensor.

14. In a motor vehicle having an electrical system, an operators position and a foot pedal assembly, an anti-theft apparatus operable to erect a locked physical barrier between said operators position and said foot pedal assembly comprising:
a pair of vertical guides mounted on either side of the foot pedal assembly;
a stackable shutter assembly slidably disposed in said guides, said shutter assembly comprising a plurality of elongate panels, said shutter assembly including an articulated linkage between said panels which allows folding of the adjacent panels with respect to one another;
a hydraulic pump motor fluidly connected to a pair of left and right hydraulic piston rod assemblies mounted on either side of the foot pedal assembly; said left and right hydraulic piston rod assemblies respectively including left and right displaceable piston rods, said piston rods fixedly attached to a portion of said shutter assembly wherein said shutter assembly can be extended and retracted by displacement of said piston rods, said retracted position permitting access to the foot pedal assembly and the extended position providing a physical barrier to said foot pedal assembly.

15. The anti-theft apparatus of claim 14, further including an actuating means electrically coupled to said hydraulic pump.

16. The anti-theft apparatus of claim 15, wherein said actuating means comprises:
an engine starting key having readable memory means having a unique identifying code stored therein;
key receiving socket mounted in the vehicle, said key receiving means having a means for reading said identifying code;
means for comparing said identifying code with previously stored code for verification; and
means for verifying said identifying code.

17. The anti-theft apparatus of claim 15, wherein said actuating means is operable to move said shutter assembly to said retracted position when said identifying code is verified.

18. The anti-theft apparatus of claim 15, wherein said actuating means moves said shutter assembly to said extended position when said key is removed from said key receiving socket.

19. The anti-theft apparatus of claim 6, further comprising a sensing means, wherein said sensing means is operable to detect intervening objects proximate to said shutter assembly in an open position, wherein detection of intervening objects will prevent said shutter assembly from lowering to said closed position.

20. The anti-theft apparatus of claim 19, wherein said sensing means is an optical sensor.
